(19) United States
(12) Patent Application Publication
(10) Pub. No.: US 2017/0221085 A1
(43) Pub. Date: Aug. 3, 2017

(54) SYSTEMS AND METHODS FOR CREATING AN OPTIONS PROGRAM USING PAYMENT TRANSACTIONS PERFORMED WITHIN A GEOGRAPHIC SECTOR

(71) Applicant: MasterCard International Incorporated, Purchase, NY (US)

(72) Inventors: Debashis Ghosh, Charlotte, NC (US); Scott Hudson, Pearl River, NY (US); Manash Bhattacharjee, Jersey City, NJ (US)

(21) Appl. No.: 15/012,364

(22) Filed: Feb. 1, 2016

(51) Int. Cl. G06Q 30/02; G06Q 20/20; G06F 17/30; G06Q 30/06

(52) U.S. Cl. CPC G06Q 30/0205; G06Q 30/0601; G06Q 20/20; G06F 17/30867

(57) ABSTRACT

A computer-implemented method for creating and managing an options program associated with payment transactions initiated in a geographic sector is described herein. The method is implemented using an analytics evaluation and management (AEM) computing device. The method includes storing a sector score associated with the geographic sector, the sector store ranking one or more financial characteristics of a plurality of merchants located in the sector. The method also includes generating an investment instrument including one or more parameters associated with the sector score, and transmitting a program initiation signal to a program interface (PI) computing device configured to maintain a virtual commodity market. The program initiation signal includes instructions causing the PI computing device to display the investment instrument on a user computing device, and provide a user of the user computing device an option to purchase the investment instrument.

### BACKGROUND OF THE DISCLOSURE

The field of the disclosure relates generally to creating and managing investment instruments included within an options program, and, more specifically, to network-based methods and systems for creating and managing an options program that uses payment transactions initiated within a geographic sector as an input to said options program.

The advent of electronic transaction processing has brought an enormous influx of data associated with payment transactions, such as where and when transactions occur, transaction amounts, and more. Such data can be processed at an aggregated level to draw conclusions about the financial health of geographic regions, at a neighborhood, city, state, or national level. Although reports of positive economic or financial outlook in a region may serve to improve the reputation of such a region, there is currently no way for the region to use these reports to directly impact their own financial “bottom line.” Accordingly, it is desirable to have a system that is configured to utilize payment transaction data for a particular geographic region to generate, manage an options program that is associated with the payment transactions data for the region, and provide a share of a commission generated by investment into the options program to the region.

### BRIEF DESCRIPTION OF THE DISCLOSURE

In one aspect, a sector analytics system is provided. The sector analytics system includes an analytics evaluation and management (AEM) computing device including a processor in communication with a memory. The processor is programmed to store a sector score associated with a geographic sector. The sector store ranks one or more financial characteristics of a plurality of merchants located in the sector in comparison to other sectors. The processor is also programmed to generate an investment instrument including one or more parameters associated with the sector score for the sector, and transmit a program initiation signal to a program interface (PI) computing device configured to maintain a virtual commodity market. The program initiation signal includes instructions causing the PI computing device to display the investment instrument on a display device of a user computing device in communication with the program interface computing device, and provide a user of the user computing device an option to purchase the investment instrument.

In another aspect, a computer-implemented method for creating and managing an options program associated with payment transactions initiated in a geographic sector is provided. The method is implemented using an analytics evaluation and management (AEM) computing device including at least one processor in communication with a memory. The method includes storing a sector score associated with the geographic sector, the sector store ranking one or more financial characteristics of a plurality of merchants located in the sector in comparison to other sectors. The method also includes generating an investment instrument including one or more parameters associated with the sector score for the sector, and transmitting a program initiation signal to a program interface (PI) computing device configured to maintain a virtual commodity market. The program initiation signal includes instructions causing the PI computing device to display the investment instrument on a display device of a user computing device in communication with the program interface computing device, and provide a user of the user computing device an option to purchase the investment instrument.

In a further aspect, a non-transitory computer-readable storage medium having computer-executable instructions embodied thereon is provided. When executed by an analytics evaluation and management (AEM) computing device including at least one processor in communication with a memory, the computer-executable instructions cause the at least one processor to store a sector score associated with a geographic sector. The sector store ranks one or more financial characteristics of a plurality of merchants located in the sector in comparison to other sectors. The computer-executable instructions also cause the at least one processor to generate an investment instrument including one or more parameters associated with the sector score for the sector, and transmit a program initiation signal to a program interface (PI) computing device configured to maintain a virtual commodity market. The program initiation signal includes instructions causing the PI computing device to display the investment instrument on a display device of a user computing device in communication with the program interface computing device, and provide a user of the user computing device an option to purchase the investment instrument.

### BRIEF DESCRIPTION OF THE DRAWINGS

FIGS. 1-9 show example embodiments of the methods and systems described herein.

FIG. 1 is an expanded block diagram of an example embodiment of a sector analytics system configured to calculate aggregated merchant analytics or “sector scores” for a geographic sector and to develop and generate a investment instrument for trading in an options program over a commodity market based on those sector scores.

FIG. 2 illustrates an example configuration of a client computing device used in the sector analytics system shown in FIG. 1.

FIG. 3 illustrates an example configuration of a server system used in the sector analytics system shown in FIG. 1.

FIGS. 4A and 4B illustrate a simplified data flow diagram for generating merchant analytics or “sector scores” for a sector, generating an investment instrument associated with the sector based on the sector scores, offering the investment instrument for sale, and dividing a commission generated by the sale of the financial between parties including the associated sector using the sector analytics system shown in FIG. 1.

FIG. 5 is an example screenshot of a user interface displayed on a user computing device of the sector analytics system shown in FIG. 1.

FIG. 6 illustrates a user computing device depicting a first screenshot of investment instruments offered for sale on a commodity market by the sector analytics system shown in FIG. 1.

FIG. 7 illustrates a user computing device depicting a second screenshot of investment instruments offered for sale on a commodity market by the sector analytics system shown in FIG. 1.

FIG. 8 is a simplified diagram of an example method for development of an investment instrument associated with merchant of a geographic sector using the sector analytics system shown in FIG. 1.

FIG. 9 is a diagram of components of one or more example computing devices that may be used the sector analytics system shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

A sector analytics system described herein is configured to calculate aggregated merchant analytics or “sector scores” for a predefined geographic region (a “sector”). In particular, the sector analytics system is associated with or integral to a payment processing network including a payment processor configured to process payment transactions initiated by cardholders using payment cards (e.g., credit cards, debit card, prepaid cards, etc.). The payment processor collects transaction data associated with these transactions for further processing. In the example embodiment, the sector analytics system is configured to receive transaction data associated with a plurality of merchants in a geographic sector and process the transaction data to calculate one or more sector scores associated with the sector based on transactions initiated at merchants located within that sector. In addition, the system is configured to present these analytics or scores to a user (e.g., an investor, buyer, or seller) on an interactive user interface. In the example embodiment, the sector scores are based upon five key characteristics of a merchant, including: growth, stability, size, traffic, and ticket size, and a “composite” or aggregation of those characteristics. These key characteristics are then averaged or otherwise combined with the same characteristics of other merchants within the sector to generate aggregated characteristics for multiple merchants included within the sector, or a sector score.

The sector analytics system includes a backend analytics evaluation and management (AEM) computing device. The AEM computing device includes a processor in communication with a memory. The AEM computing device is in communication with at least one database for storing information, as described further herein. The AEM computing device is configured to calculate and/or receive one or more sector scores for a sector, for example, a current sector score and one or more past sector scores (e.g., from previous months). As another example, the AEM computing device may calculate and/or receive each of the six above-described sector scores for the sector.

The following discussion is associated with the generation of aggregated merchant analytics, or the sector scores for geographic sectors. In certain embodiments, the AEM computing device may perform any or all of the methods described to generate the sector scores. Alternatively, the AEM computing device may receive generated sector scores from a third party, such as a merchant analytics computing device associated with a payment processing network. Accordingly, the description uses “AEM computing device” to refer to any specialized computing device designed to implement these processes, and may include the AEM computing device and/or additional or alternative specialized computing devices.

### Sector Definition Phase

The AEM computing device is configured to define a plurality of “merchant sectors,” “sector locations,” or “sectors” (used interchangeably herein). More specifically, the AEM computing device is configured to divide up a geographic region (e.g., a country, state, city, county, etc.) into a plurality of sectors containing merchants therein (i.e., a subset of a plurality of merchants located within the geographic region). The sector may be defined by a geographic boundary containing the plurality of merchants therein. In an example embodiment, sectors are defined according to census blocks, and the geographic boundaries of a sector correspond to the geographic boundaries of the census block. In some embodiments, each sector includes a minimum of five merchants. Accordingly, where a sector is initially defined as a census block including fewer than five merchants, the geographic boundaries of the sector are expanded or adjusted to include at least one additional census block until the sector includes at least five merchants. In some embodiments, each sector may include up to n merchants, where n is an integer greater than five.

As described above, sectors may be defined on a geographic scale as small as a census block (which may be as small as a city block). However, sectors at the census block level may be “rolled up” or aggregated into larger, block-group level sectors, which may correspond to block groups as defined by the United States Census Bureau. Block-group level sectors may be rolled up or aggregated into large sectors, such as city- or county-level sectors, which themselves may be rolled up or aggregated into state- or nation-level sectors.

As will be described further herein, the AEM computing device is configured to determine “aggregated merchant analytics” for each sector based at least in part on received transaction data for the merchants located in the sector. The merchant analytics are indicative of the financial success of the sector relative to other sectors in that geographic region. For example, the AEM computing device may rank or score a sector relative to other sectors in a county or in a state. In one example embodiment, the AEM computing device is configured to determine and provide merchant analytics, which may include a numerical score, for a sector based on aggregated merchant analytics for individual merchants located within the sector. For example, if a sector includes five merchants, the AEM computing device may process transaction data for each individual merchant to generate analytics for each particular merchant. The AEM computing device may then aggregate the individual analytics to determine “aggregated merchant analytics” for the sector as a whole. A weighted average may also be used, which may give more weight to certain merchants in the sector.

The AEM computing device may store transaction data, defined sectors, and/or merchant analytics (aggregated and/or individual) in a database. Each merchant for which associated transaction data and/or scores are stored may be indexed or identified in the database by at least one sector identifier and/or by merchant industry. Accordingly, the AEM computing device may be configured to not only provide analytics for sectors, but may also be configured to provide analytics for particular industries and/or for particular merchants within that industry. Moreover, a particular merchant may be indexed by (i.e., be located in) multiple sectors. For example, a merchant at Charlotte-Douglas Airport may be included in a “block” sector (named as such because such a sector may take up an area as small as a city block, in some embodiments the smallest available sector division), a “block group” sector (representative of an area that is small but that includes at least one “block” sector, for example, a census tract), a Mecklenburg County sector, a Charlotte (city) sector, a North Carolina sector, and a United States sector.

In the example embodiment, the AEM computing device defines the plurality of sectors, and the sector definitions do not change throughout an investment or expiration period of investment instruments generated in association with those sectors. In other words, the “sectors” for which investment instruments are generated and subsequently purchased stay the same, such that investment instruments associated with each sector may be evaluated for their value after the expiration or conversion period for the investment instruments has passed.

### Setup Phase

In the example embodiment, the AEM computing device is configured to receive information describing a merchant during a configuration period referred to as a “Setup Phase”. In an example embodiment, a user (e.g., a commercial real estate owner or lender, a business owner, a marketing director, a financial officer, etc.) may access the AEM computing device (directly or via any suitable client user computing device in communication with the AEM computing device) and may provide such information. Information describing or associated with particular merchants may be referred to as “merchant definitions,” and may be used to identify and/or evaluate (e.g., score) each merchant. Merchant definitions include information associated with merchant locations including property identifiers, property location information, and merchant classification information.

“Property identifiers” may include known names (or any suitable unique alphanumeric identifier) of commercial real estate assets of which a merchant is a tenant, owner, etc. (e.g., “XYZ Mall”). In an example embodiment, the AEM computing device uses property identifiers to designate a location for each merchant.

“Property location information” may include any information defining the geographic location of a merchant. In some examples, property location information may include physical addresses, geographic coordinates in latitude and longitude, elevation information (e.g., a floor or floors of a building associated with a commercial real estate asset), and any other suitable information. In some examples, property location information may include boundary information defining a physical area (or areas) containing the merchant. In an example embodiment, property location information may be used by the AEM computing device to identify the merchant graphically (i.e., to provide visually mapped information showing the physical location of the merchant).

“Merchant classification information” includes information categorizing the merchant within categories that may be relevant to the monitoring of the value of the merchant. For example, merchant classification information may categorize a merchant according to a particular industry, location, or other classification, for example, “retail”, “office”, “warehouse”, “manufacturing”, “healthcare,” “outdoor mall”, “indoor mall” and any other suitable information.

### Evaluation Phase

In an example embodiment, the AEM computing device generates analytics (e.g., a sector score) associated with a merchant or a sector in a process that may be referred to as the “Evaluation Phase”. The AEM computing device is configured to generate the analytics based on received transaction data associated with the merchant or sector. As used herein, “transaction data” may include transaction amounts, merchant identifiers, account identifiers, associated time and date stamps, and data descriptive of the product(s) purchased. Merchant identifiers may include an identifier of the merchant at which the transaction was initiated as well as an identifier of the physical location (e.g., a street address, geographic coordinates, etc.) of the merchant. In the example embodiment, AEM computing device receives transaction data from a payment processor integral to or associated with a payment processing network. In some embodiments, the transaction data is anonymized and aggregated by merchant prior to receipt by the AEM computing device (i.e., no personally identifiable information (PII) is received by the AEM computing device). In other embodiments, the merchant analytics computing device may be configured to receive transaction data that is not yet anonymized and/or aggregated, and thus may be configured to anonymize and aggregate the transaction data. In such embodiments, any PII received by the AEM computing device is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

The AEM computing device may generate multiple merchant analytics for each merchant and may generate “aggregated merchant analytics” for each sector. Aggregated merchant analytics refer generally to an average, weighted average, or any other aggregation of individual merchant analytics generated for merchants located in the sector. For example, the “merchant analytics” may include at least one of a growth score, a stability score, a size score, a ticket size score, a traffic score, and a composite score for each sector. A “growth score” is a ranking of the growth of the sector relative to other sectors in the geographic region, wherein “growth” refers generally to sales revenue growth over a period of time. A “stability score” is a ranking of the stability of the sector, wherein “stability” refers generally to a maintenance of sales revenue within a range of sales revenues around an average. A “size score” is a ranking of the size of the sector, wherein “size” refers generally to total sales revenue. A “traffic score” is a ranking of the traffic of the sector, wherein “traffic” refers generally to a number of monthly transactions. A “ticket size score” is a ranking of the ticket size of the sector, wherein “ticket size” refers generally to a transaction amount, and may be calculated by dividing the size by the traffic (e.g., dividing sales revenue by the number of transactions). A “composite score” is a composite of the previous five scores (growth, stability, size, traffic, and ticket size), to provide an overall ranking of the sector. Where the general term “score” or “sector score” without a modifier is used herein, it may refer collectively to any or all of the preceding scores to describe characteristics shared by some or all of the scores. Each of these sector scores (collectively “analytics”) may be generated for each merchant within a sector and may be subsequently aggregated to generate aggregated merchant analytics for the sector.

In the example embodiment, the sector score is normalized to be between 0 and 1,000. In some embodiments, a higher score indicates a “better” sector (i.e., a higher relative ranking). For example, a sector with a score of 800 may rank higher on any or all of the above-described factors than a sector with a score of 300. A “better” sector refers to a sector that is preferred over other sectors (or is performing better) based upon the financial transactions performed at merchants located within that sector.

In the example embodiment, the AEM computing device receives transaction data associated with merchants that spans a period of time. For example, the AEM computing device may receive and process transaction data for a merchant or sector that spans between one month and at least two years prior to the date of receipt. Accordingly, the AEM computing device may generate the analytics as functions of time. For example, a growth score would be meaningless if there were no transaction data for a past date from which to determine relative growth. In the example embodiment, the AEM computing device generates analytics for each merchant and/or sector using 12 months' or one year's worth of transaction data for the merchant and/or sector. Accordingly, a growth score is representative of the growth of the sector over the past year, the stability score is representative of the stability of the sector over the past year, etc. In other embodiments, the AEM computing device may be further configured to determine a “spot” score of any of the above-described scores, wherein a “spot” score refers generally to a score calculated for a shorter period of time, for example, three months as opposed to twelve months. The spot score may be used to determine changes in the characteristics of the merchant over a short period of time that may be masked or hidden when scoring the merchant over a year.

In one embodiment, the AEM computing device may determine a growth score for a merchant using the received transaction data over a period of time (e.g., a year). The AEM computing device determines the increase or decrease in the sales revenue for the merchant over that year based on the aggregation of all of the transaction data associated with the merchant. Additionally or alternatively, the growth for a merchant may be calculated by fitting total sales revenue to a regression line and tracking resulting slopes. Additionally or alternatively, quarterly sales revenue (i.e., 3-months' worth of sales revenue data) may be calculated and compared to the corresponding quarter of the previous year. As the growth score is a relative ranking, the AEM computing device may compare the determined growth of each merchant prior to providing the numerical growth score for each merchant. The AEM computing device may then use the growth scores of all of the merchants in a sector to determine an aggregated growth score for the sector (e.g., an average or weighted average of the merchant growth scores for the merchants within the sector). Alternatively, the AEM computing device may use the determined growth of each merchant in a sector to determine an aggregated growth score for the sector and may subsequently compare sectors. The AEM computing device may then provide the (numerical) growth score for the sector.

In one embodiment, the AEM computing device may determine a stability score for a merchant using the received transaction data over a period of time (e.g., a year). The stability of a merchant is a metric or analytic of the volatility of the merchant's cash flow. The AEM computing device may determine an average sales revenue for the merchant over a year or may receive an average sales revenue for the merchant (which may be an “expected” average sales revenue or other value received from a user associated with the merchant or may be retrieved from a database). The AEM computing device may then determine a range around that average (e.g., one standard deviation, a certain percentage or fraction of the average, or any other suitable range) which indicates stable sales revenue. Using aggregated transaction data, the AEM computing device identifies whether the merchant had sales revenue within that range. Falling outside of the range indicates less stable sales revenue and lowers the ranking of the merchant in terms of stability. The AEM computing device may use monthly transaction data to determine, at each month, whether the merchant had sales revenue within the predetermined range. Alternatively, the AEM computing device may use transaction data from any other interval (i.e., each week, every two weeks, over the year, etc.) to determine the stability of the sales revenue of the merchant. As the stability score is a relative ranking, the AEM computing device may compare the determined stability of each merchant prior to providing the numerical stability score for each merchant. The AEM computing device may then use the stability scores of all of the merchants in a sector to determine an aggregated stability score for the sector (e.g., an average or weighted average of the merchant stability scores for the merchants within the sector). Alternatively, the AEM computing device may use the determined stability of each merchant in a sector to determine an aggregated stability score for the sector and may subsequently compare sectors. The AEM computing device may then provide the (numerical) stability score for the sector.

In one embodiment, the AEM computing device may determine a size score for a merchant using the received transaction data associated with the merchant over a period of time (e.g., a year). The size metric or analytic may be considered a proxy analytic for how large a particular merchant or business is. The AEM computing device may aggregate the total sales revenue for the merchant for each month in the year, or over the whole year. As the size score is a relative ranking, the AEM computing device may compare the determined size of each merchant prior to providing the numerical size score for each merchant. The AEM computing device may then use the size scores of all of the merchants in a sector to determine an aggregated size score for the sector (e.g., an average or weighted average of the merchant size scores for the merchants within the sector). Alternatively, the AEM computing device may use the determined size of each merchant in a sector to determine an aggregated size score for the sector and may subsequently compare sectors. The AEM computing device may then provide the (numerical) size score for the sector.

In one embodiment, the AEM computing device may determine the traffic score for a merchant using the received transaction data over a period of time (e.g., a year). The AEM computing device may identify a number of transactions completed at the merchant for the entire year to determine the traffic for the merchant, or may identify the number of transactions for each month in the year. Additionally or alternatively, other data may be used to determine the traffic at a merchant, including mobile device signal data, as described in co-owned U.S. patent application Ser. No. 14/708,020, the contents of which are hereby incorporated by reference. As the traffic score is a relative ranking, the AEM computing device may compare the determined traffic of each merchant prior to providing the numerical traffic score for each merchant. The AEM computing device may then use the traffic scores of all of the merchants in a sector to determine an aggregated traffic score for the sector (e.g., an average or weighted average of the merchant traffic scores for the merchants within the sector). Alternatively, the AEM computing device may use the determined traffic of each merchant in a sector to determine an aggregated traffic score for the sector and may subsequently compare sectors. The AEM computing device may then provide the (numerical) traffic score for the sector.

In one embodiment, the AEM computing device may determine a ticket size score for a merchant using the received transaction data over a period of time (e.g., a year) and/or using the determined size and traffic for the merchant. The ticket size (also referred to herein as an “average ticket size”) enables improved visibility into the types of merchant in a sector. A low average ticket size, for example, around $5, may indicate a sector includes restaurants or coffee shops. A higher average ticket size, for example, around $2,000, may indicate a sector includes jewelry stores, electronics merchants, or furniture stores. The AEM computing device may calculate the ticket size for the merchant by dividing a sales revenue of the merchant by a number of transactions. Alternatively, the AEM computing device may calculate the ticket size by dividing a size of the merchant as determined above, by a traffic of the merchant, as determined above. As the ticket size score is a relative ranking, the AEM computing device may compare the determined ticket size of each merchant prior to providing the numerical ticket size score for each merchant. The AEM computing device may then use the ticket size scores of all of the merchants in a sector to determine an aggregated ticket size score for the sector (e.g., an average or weighted average of the merchant ticket size scores for the merchants within the sector). Alternatively, the AEM computing device may use the determined ticket size of each merchant in a sector to determine an aggregated ticket size score for the sector and may subsequently compare sectors. The AEM computing device may then provide the (numerical) ticket size score for the sector.

In one embodiment, the AEM computing device may determine a composite score for a merchant based on the growth, stability, size, traffic, and/or ticket size score for the merchant. The composite score may be an average of all five scores, may be a weighted average of all five scores, or may be any other combination or aggregation of the five scores for the merchant location. The composite score for a sector may be an average of all five scores, may be a weighted average of all five scores, or may be any other combination or aggregation of the five scores for the sector (e.g., an average or weighted average of the merchant composite scores for the merchants within the sector). Alternatively, the composite score for a sector may be an average, weighted average, or any other aggregation of the composite scores of the merchants in the sector. The composite score is intended to be an “at-a-glance” ranking of the relative success of the sector, taken as a function of the five identified characteristics that may reflect the success of a business.

In some embodiments, the AEM computing device may be configured to generate and store merchant analytics for a merchant and/or a sector over multiple periods of time. For example, the AEM computing device may initially generate a score based on data having timestamps from Jun. 1, 2013-Jun. 1, 2014 and may store that score as Score 1. The AEM computing device may then generate a score based on data having timestamps from Jul. 1, 2013-Jul. 1, 2014, and may store that score as Score 2. The AEM computing device may store N scores (or any other analytics) for a merchant and/or a sector, wherein N is an integer greater than one. Accordingly, the AEM computing device may store a time series of scores (or any other analytics) for a merchant and/or a sector, which collects all N scores for the merchant and/or the sector sequentially (i.e., in order of time, from oldest to newest).

### User Interface

The AEM computing device may further configured to facilitate the display of an interactive graphical user interface (UI) on a user computing device of a user. The UI is configured such that the user may easily view aggregated merchant analytics for a sector and/or for a particular industry, for example, as a graphical representation displayed on a map. In one embodiment, the UI is populated with data that is updated on a monthly basis, however, in other embodiments, the UI may be populated with data updated at any other interval (e.g., weekly, daily, etc.).

In one embodiment, the user may search by location to find a geographic region (e.g., state, city, zip code, zip+4, county, neighborhood) in which the user is interested. The UI displays the geographic location divided into defined sectors. In some embodiments, the UI enables a user to “zoom in” and “zoom out” on the view. Zooming in may provide a view of the sectors at a more granular level. Zooming out may provide a view of sectors aggregated into larger geographic regions, for example, by city, county, or state. In the example embodiment, displayed sectors are colored or shaded according to the strength of generated merchant analytics, wherein a darker or more saturated color or shade indicates stronger analytics (e.g., more successful sectors). Accordingly, the user may easily discern sectors with stronger analytics, with only a single glance. In other embodiments, lighter colors may indicate stronger analytics. In still other embodiments, the sectors may not be colored or shaded at all.

As described herein, the UI may provide to user an option to view sectors according to different metrics (e.g., according to the various scores described above included within the merchant analytics). In addition, the UI may provide other tools to the user for navigation of the merchant analytics and for a “deeper dive” into the granularity of the analytics.

### Options Program

Once the AEM computing device calculates such sector scores, as described above, the AEM computing device is also configured to create and manage an investing process for an options program including one or more investment instruments associated with a sector and merchant analytics (sector scores) thereof. The AEM computing device is configured to analyze the calculated sector score for trends, threshold amounts, maxima, minima, and/or other characteristics. Based on such analysis, the AEM computing device is configured to generate an investment instrument associated with the sector and the corresponding sector score. The AEM computing device manages offering the investment instrument(s) for sale and trading by investors (e.g., buyers or sellers) and tracking and recording such sales and trades. In the example embodiment, each purchase, sale, or trade of an investment instrument generates a commission, a portion of which is provided to the associated sector as a source of income.

In one embodiment, the investment instrument is a binary option. Binary options include parameters such as a proposition, value, and expiration interval. For example, the binary option includes a proposition that a sector score of a sector associated with the binary option will increase by a certain amount within the expiration interval, or a predetermined period of time associated with that particular binary option (e.g., one month, six months, one year, etc.). A buyer purchases or sells the binary option based on their expectation of the binary outcome of the binary option's proposition. Specifically, a buyer purchases the binary option if they expect the proposition to occur (e.g., “yes, the sector score will increase by the certain amount within the expiration interval”), or sells the binary option if they expect the proposition will not occur (e.g., “no, the sector will not increase by the certain amount within the expiration interval”). The AEM computing device records the purchase (“buy” or “sell”), including a commission generated by the purchase, and is configured to monitor the binary option over the expiration interval.

After the expiration interval has passed, the AEM computing device retrieves the parameters associated with the binary option, in order to determine whether the user has earned or lost money (i.e., whether the proposition was fulfilled or not fulfilled). In some embodiment, the AEM computing device generates or receives a current sector score for the sector associated with the binary option, the current sector score corresponding to the end of the expiration interval (as opposed to a “past” sector score corresponding to the time of purchase), and compares the current sector score to the proposition parameter. The AEM computing device transmits a signal to a user computing device associated with a purchase of the binary option to alert the user about whether they have earned or lost money. In other embodiments, the investment instrument may be any other suitable investment instrument, such as a stock option, an equity option, a bond, and/or more complex options (e.g., puts/calls). Any other investment instruments may include additional, fewer, or different parameter associated therewith.

The AEM computing device may generate the investment instrument and associated parameters based on a current sector score associated with a sector. Additionally or alternatively, the AEM computing device may analyze past sector scores for trends, averages, peaks, lows, or any other characteristics, and generate the investment instrument based on the analysis. For example, the AEM computing device may determine that the sector score for the sector has been trending upwards or increasing for three months prior to the generation of the investment instrument. Accordingly, the AEM computing device may generate an investment instrument with a proposition parameter of a further increase (e.g., as a percentage, based on the trend, or as a discrete number, such as “increase 10 points”) over the predetermined time period.

In some embodiments, the parameters of the investment instrument are determined based on both sector score(s) and external events, including weather, social, or political happenings. For example, the AEM computing device generates an investment instrument associated with Charleston, S.C. A hurricane has just hit Charleston and has likely significantly affected the local economy. The AEM computing device may generate a proposition parameter of future decline in one or more sector score for Charleston, for example, “The composite score for Charleston, SC, will decrease by over 25 points in two months.” Accordingly, in some embodiments, the AEM computing device may access one or more news feeds to determine one or more current events associated with a sector and an anticipated effect of the current event on a sector score. In some embodiments, the AEM computing device in configured to generate a plurality of investment instruments for a single sector, for example, including propositions associated with different sector scores, different outcomes, and/or different expiration intervals or predetermined periods of time.

In some embodiments, a price parameter of the investment instrument is correlated with the current sector score. For example, the investment instrument may include a stock or equity option in a particular sector (e.g., a city). The price of the stock option may be equal to the sector score or otherwise correlated to the sector score (e.g., a fixed percentage of the sector score). Accordingly, stock options for better performing sectors are priced higher that stock options for sectors performing comparatively poorly, such that a commodity market including these “sector investment instruments” functions similarly to traditional corporation-based stock markets. The corresponding sector may accordingly raise funds by requesting the generation of such investment instruments and subsequent purchase by investors. In alternative embodiments, the price of the investment instrument is not correlated with any sector score but may be fixed or based on any other factor (e.g., a commodity market factor). For example, the price of binary options may be based on the current buy/sell ratio of the binary option and the desired action to be taken on the binary option (i.e., the price of buying vs. the “price” of selling).

The AEM computing device subsequently transmits instructions to a frontend program interface (PI) computing device configured to maintain infrastructure for a virtual commodity market, the instructions causing the PI computing device to offer the generated investment instrument(s) for sale to investors on the commodity market within an option program. More specifically, the AEM computing device transmits the investment instrument or a record thereof to the PI computing device in an instrument transmission signal including instructions to display options program including the investment instrument on a user computing device of a user and offer the investment instrument for sale to the user. The instrument transmission signal may further include instructions for the PI computing device to transmit an activation signal to the user computing device, such that the user computing device activates to display the investment instrument to the user. The commodity market is accessed by users (e.g., buyers and sellers) electronically, via user computing devices (e.g., smartphones, personal computers, tablets, etc., over wireless or wired connections). In certain embodiments, the sector analytics system maintains the PI computing device (and, therefore, the commodity market). In other embodiments, a third party maintains the PI computing device.

After a purchase of an investment instrument has been made, the AEM computing device is configured to receive a purchase signal from the PI computing device and/or the user computing device identifying the purchase. The purchase of the investment instrument initiates generation of the commission (also referred to as “purchase commission”). The amount of the generated commission may be correlated with the value of the investment instrument or may be fixed. The AEM computing device is configured to divide the amount of the commission such that certain parties associated with the investment instrument receive a share. More specifically, the AEM computing device divides the amount of the commission between the party that maintains the commodity market (i.e., the party associated with the PI computing device), the sector associated with the purchased investment instrument, and the sector analytics system. In the example embodiment, the AEM computing device is configured to transmit a commission signal to a financial interchange network including instructions to withdraw funds in the commission amount from a financial account associated with the investor. The instructions further cause the financial interchange network to transmit funds of the divided commission amount, or “shares,” to a financial account associated with each respective party. The shares to each party may be different or may be the same. Accordingly, the sector analytics system facilitates provision of an additional source of revenue to sectors having associated investment instruments, or participating in the options program, in the commodity market. These sectors may in turn be encouraged to invest in opportunities for increasing financial activity in their sectors, for example, incentivizing additional and/or higher-ticket merchants to be located in their sector.

In addition, the AEM computing device is configured to store a record of the purchase (e.g., who bought which investment instrument, how many were purchased, parameters associated with the investment instrument at the time of purchase, etc.). If the purchased investment instrument is associated with an expiration interval, the AEM computing device is configured to calculate an expiration date. On the expiration date, the AEM computing device analyzes the purchased investment instrument and determines whether the investor has earned or lost money. For example, the AEM computing device may retrieve parameters of the purchased investment instruments and receive or generate a current or updated sector score for the associated sector. The AEM computing device may then compare the current or updated sector score with the proposition of the investment instrument or the initial purchase value of the investment instrument (e.g., if the value of the investment instrument is associated with the sector score) and determines whether the investor has earned or lost money.

It should be understood that the AEM computing device may perform these processes for investment instruments not associated with an expiration interval, but rather associated with a conversion date (e.g., a date on which the investment instrument is being sold, converted, “cashed-out”, etc.). The AEM computing device may, in such embodiment, receive a conversion signal indicating that a purchaser of the investment instrument wishes to convert the investment instrument. The AEM computing device may then generate or receive an updated sector score or the sector corresponding to the conversion date (the date on which the conversion signal was received) and compare the updated sector score to the parameters of the purchased investment instrument. For example, if the investment instrument is a stock option, the AEM computing device may compare the value parameter of the stock option corresponding to the purchase of the investment instrument with the updated sector score (and/or to an updated value parameter corresponding to the updated sector score). The AEM computing device transmits an alert signal to the respective user computing device with a message indicating how much the investor earned or lost. In other embodiments, the AEM computing device is configured to monitor a state of the investment instrument (e.g., a changing sector score may correlate to a change in value of the investment instrument) such that, when an investor wishes to sell the investment instrument, the AEM computing device transmits an alert signal to the respective user computing device with a message indicating the current value of the investment instrument for the sale.

Subsequent transmissions of the investment instrument between parties over the commodity market (i.e., through communication with the PI computing device) may be permitted, such as sales and/or trades of the financial instrument. In the example embodiment, trading, selling, and/or other transmissions of the investment instrument by the (original) investor or buyer generates another commission from the buying, selling, and/or trading party/parties, which may be the same as or different from the purchase commission. As described above, the AEM computing device is configured to divide the amount of these commissions between the party that maintains the commodity market, the sector associated with the purchased investment instrument, and the sector analytics system.

Through the monitoring of financial transactions initiated at merchants within geographic sectors, the systems and methods are configured to facilitate (a) integration of transaction data into the generation of merchant analytics by linking transaction data received from interchange networks (or payment networks) to such analytics, (b) improvement of the visualization of sector value or success, relative to other sectors and over time, and (c) utilization of sector value as an opportunity for revenue for that sector.

The technical effects of the systems and methods described herein can be achieved by performing at least one of the following steps: (i) storing a sector score associated with the geographic sector, the sector store ranking one or more financial characteristics of a plurality of merchants located in the sector in comparison to other sectors; (ii) generating an investment instrument including one or more parameters associated with the sector score for the sector; and (iii) transmitting a program initiation signal to a program interface (PI) computing device configured to maintain a virtual commodity market, the program initiation signal including instructions causing the PI computing device to: (a) display the investment instrument on a display device of a user computing device in communication with the program interface computing device; and (b) provide a user of the user computing device an option to purchase the investment instrument.

The following detailed description of the embodiments of the disclosure refers to the accompanying drawings. The same reference numbers in different drawings may identify the same or similar elements. Also, the following detailed description does not limit the claims.

Described herein are computer systems such as analytics evaluation and management computing devices, program interface computing devices, and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the development and sale of financial instruments associated with a financial analytics of a geographical sector.

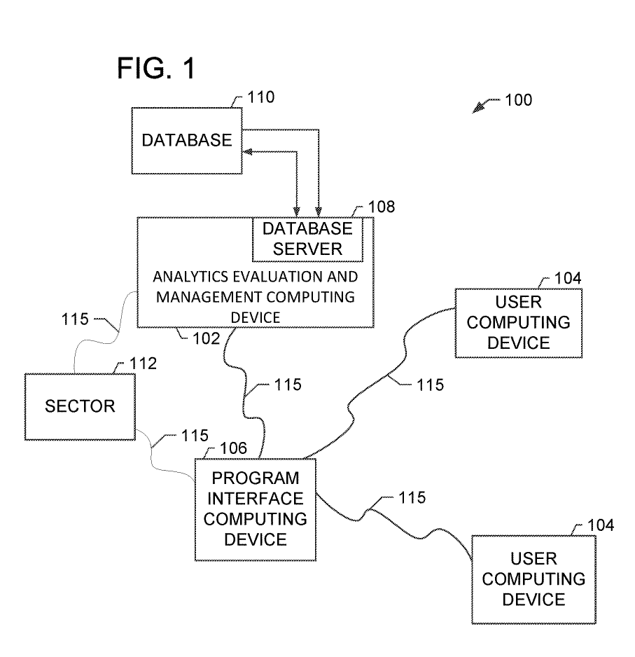

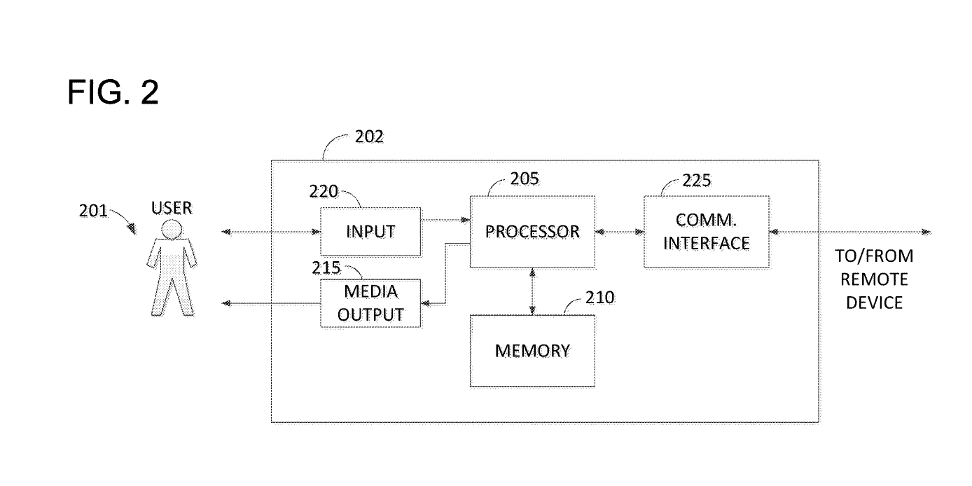

FIG. 1 is an expanded block diagram of an example embodiment of a sector analytics system 100 configured to calculate aggregated merchant analytics or “sector scores” for sectors 112 and to develop and generate a investment instrument for trading in an options program over a commodity market based on those sector scores. More specifically, in the example embodiment, sector analytics system 100 includes an analytics evaluation and management (AEM) computing device 102, and a plurality of client sub-systems, also referred to as user computing devices 104, in communication with AEM computing device 102. In one embodiment, user computing devices 104 are computers including a web browser, such that AEM computing device 102 is accessible to user computing devices 104 using the Internet and/or using network 115. User computing devices 104 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. User computing devices 104 may include systems associated with users of the commodity market (e.g., buyers and sellers) as well as external systems used to store data. User computer devices 104 could be any device capable of interconnecting to the Internet including a web-based phone, PDA, or other web-based connectable equipment.

AEM computing device 102 is also in communication with a program interface (PI) computing device 106 using network 115. PI computing device 106 is configured to maintain the virtual commodity market and to make the commodity market and options programs thereon accessible to user computing devices 104, for example, using the Internet or network 115 (e.g., in a web browser and/or software application). At least one of AEM computing device 102 and PI computing device 106 may be in communication with a sector computing device 112 (referred to as “sector 112”). AEM computing device 102 and/or PI computing device 106 may receive information from and/or transmit information to sector 112 associated with investment instruments being offered for sale and purchased that are related to sector 112, as well as information regarding commissions generated by those purchases.

A database server 108 is connected to database 110, which contains information on a variety of matters, as described below in greater detail. In one embodiment, centralized database 110 is stored on AEM computing device 102 and can be accessed by potential users at one of user computing devices 104 by logging onto AEM computing device 102 through one of user computing devices 104. In an alternative embodiment, database 110 is stored remotely from AEM computing device 102 and may be non-centralized. Database 110 may be a database configured to store information used by AEM computing device 102 including, for example, sector scores, current events, transaction data, investment instruments, and/or options programs.

Database 110 may include a single database having separated sections or partitions, or may include multiple databases, each being separate from each other. Database 110 may store transaction data generated over a payment processing network, the transaction data associated with transactions initiated by cardholders using a payment card. Transaction data may include, for example, payment amount, merchant identifier, cardholder identifier, location identifier, account identifiers, and/or additional information. Database 110 may also store merchant information including a merchant identifier that identifies each merchant registered to use the network, and instructions for settling transactions including merchant bank account information.

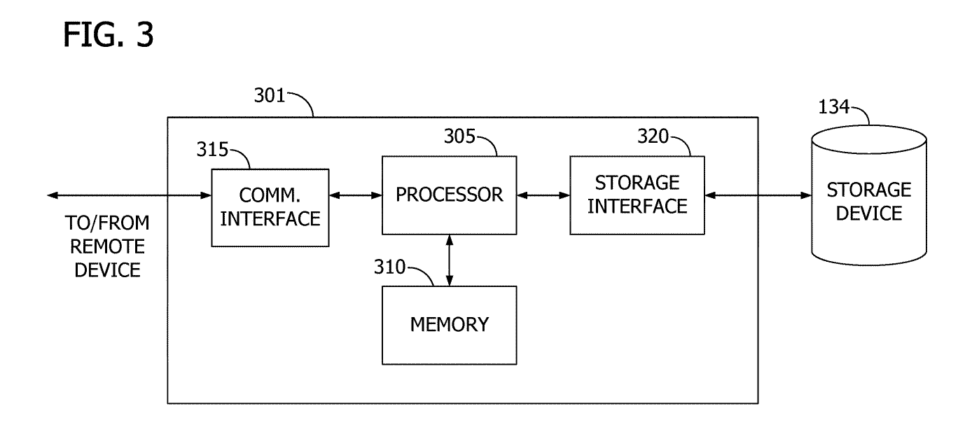

FIG. 2 illustrates an example configuration of a client computing device 202. Client computing device 202 may include, but is not limited to, client systems (“client computing devices”) 104. Client computing device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer-readable media.

Client computing device 202 also includes at least one media output component 215 for presenting information to a user 201 (e.g., a user of a commodity market, such as a buyer or seller). Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 202 includes an input device 220 for receiving input from user 201. Input device 220 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 215 and input device 220.

Client computing device 201 may also include a communication interface 225, which is communicatively couplable to a remote device such as analytics evaluation and management (AEM) computing device 102 and/or PI computing device 106 (both shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer-readable instructions for providing a user interface to user 201 via media output component 215 and, optionally, receiving and processing input from input device 220. A user interface may include, among other possibilities, a web browser and client application. Web browsers enable users 201 to display and interact with media and other information typically embedded on a web page or a website from a web server (e.g., PI computing device 106). A client application allows users 204 to interact with a server application associated with, for example, a commodity market. The user interface, via one or both of a web browser and a client application, facilitates display and purchase of investment instruments developed by AEM computing device 102 and offered for sale via PI computing device 106.

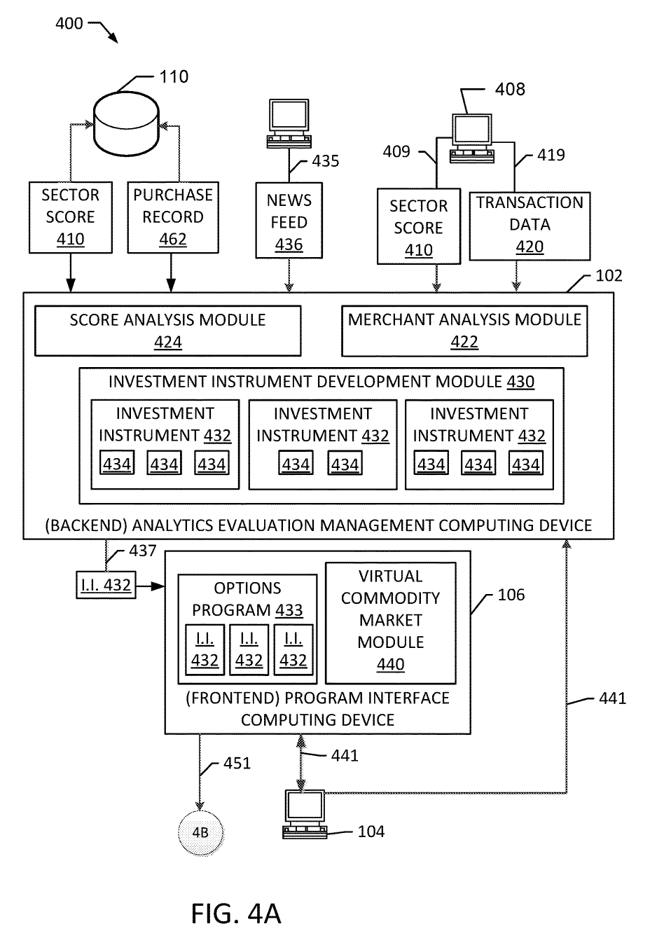

FIG. 3 illustrates an example configuration of a server system 301 such as analytics evaluation and management (AEM) computing device 102 and/or PI computing device 106 (both shown in FIG. 1) used to develop and/or offer for sale investment instruments associated with a geographic sector as part of an options program, in accordance with one example embodiment of the present disclosure. Server system 301 may also include, but is not limited to, database server 108 (also shown in FIG. 1).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to provide an interactive user interface and/or to view investment instruments for sale) from a client system 104 via the Internet, as illustrated in FIG. 1.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

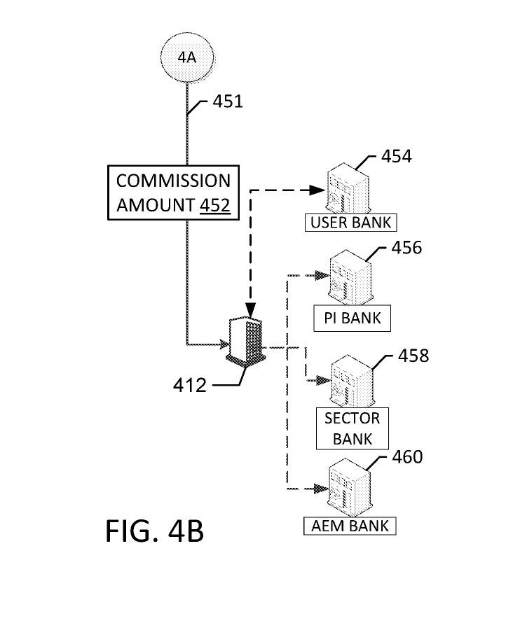

FIGS. 4A and 4B illustrate a simplified data flow diagram 400 for generating merchant analytics or “sector scores” for a sector, generating an investment instrument associated with the sector based on the sector scores, offering the investment instrument for sale, and dividing a commission generated by the sale of the financial between parties including the associated sector. As described herein, analytics evaluation and management (AEM) computing device 102 stores a plurality of sector scores 410 in database 110 (shown in FIG. 1). In the illustrated embodiment, AEM computing device 102 may further retrieve sector score(s) 410 from database 110.

In one embodiment, AEM computing device 102 receives sector score(s) 410 from a merchant analytics computing device 408. Merchant analytics computing device 408 may be associated with a transaction processor 412 (see FIG. 4B) configured to process transaction data 420. Transaction data 420 is associated with transaction initiated at merchant locations by cardholders using a payment card, and may include a payment amount, merchant identifier, cardholder identifier, account identifier, product identifier, location identifier, and/or additional information. Accordingly, in this embodiment, merchant analytics computing device 408 may use transaction data 420 to generate sector score(s) 410 for merchants located within a sector, and may transmit a signal 409 including sector score(s) 410 to AEM computing device 102.

In another embodiment, AEM computing device 102 receives a signal 419 including transaction data 420 from merchant analytics computing device 408 (and/or transaction processor 412, or any other computing device associated with a financial transaction processing network, not shown). In this embodiment, AEM computing device 102 is configured to generate sector score(s) 410 as described herein using a merchant analysis module 422.

AEM computing device 102 may store a plurality of sector scores 410 associated with a plurality of sectors (e.g., a plurality of sector scores 410 associated with a single sector and/or a plurality of sector scores 410 each for a plurality of sectors). Sector score(s) 410 may apply to a specific period or interval of time (e.g., one month, two months, one year). Accordingly, AEM computing device 102 may generate and/or store a plurality of sector scores 410 each encompassing a different period of time for a particular sector.

AEM computing device 102 further includes a score analysis module 424 configured to analyze received, generated, and/or stored sector score(s) 410. For example, score analysis module 424 may analyze sector score(s) 410 for temporal trends (e.g., increases or decreases), for maxima or minima, for threshold fluctuations, and/or according to any other parameter.

AEM computing device 102 also includes an investment instrument development module 430. Investment instrument development module 430 is configured to generate one or more investment instruments 432 including associated parameters 434. Each investment instrument 432 is associated with a sector, such a particular city or state. Parameters 434 may include expiration period, proposition, value or price, and/or any other parameter 424 descriptive of and/or associated with the respective investment instrument 432. In the illustrated embodiment, investment instrument development module 430 is configured to use output from score analysis module 424 and/or received, stored, and/or generated sector scores 410 to develop investment instruments 432. For example, investment instrument development module 430 may receive an indication from score analysis module 424 that a sector score 410 for a particular sector is trending upwards and has a current value X. Investment instrument development module 430 may then generate a investment instrument 432 having a proposition parameter 434 indicating that the sector score 410 for that sector will be X+Y by the end of an expiration period parameter 434. As another example, investment instrument development module 430 may identify that a sector score 410 for a particular sector is Z. Investment instrument development module 430 may generate an investment instrument 432 having a value or price parameter 434 of Z.

In some embodiments, investment instrument development module 430 is further configured to leverage external events not directly related to a sector score 410 for a sector to generate an investment instrument. AEM computing device 102 may be configured to receive a news feed signal 435 including a news feed 436 from a third-party computing device 438. Third-party computing device 438 may be associated with a news or reporting organization, a publishing organization, a search engine, any/or any other party generating news feed(s) 436, for example, for a subscription or service. AEM computing device 102 may be configured to parse news feed 436 for stories, publications, articles, newsletters, reports, and/or other information associated with a sector (referred to collectively as “current events”). AEM computing device 102 may substantially continuously parse news feed 436 and may index current events according to sector. AEM computing device 102 may then store indexed current events in database 110. Additionally or alternatively, AEM computing device 102 may be configured to search or crawl news feed 436 for current events associated with one particular sector in discrete processes, then index and/or store those current events.

AEM computing device 102 may be further configured to analyze (e.g., using score analysis module 424, investment instrument development module 430, merchant analysis module 422, and/or a separate processing module, not shown) the parsed, indexed, and/or stored current events for a particular sector to determine an actual or potential score impact associated therewith. For example, AEM computing device 102 may identify a current event such as a weather event or social event associated with a particular sector. ODMI computing device 102 may further identify an effect of the current event on the score (e.g., by identifying a trend, maximum, minimum, or fluctuation in sector score 410 after the current event) and/or may predict a potential effect of the current event on the score (e.g., for a very recent event). Accordingly, investment instrument development module 430 may be further configured to leverage an actual or potential effect of a current event on a sector score 410 in generating an investment instrument 432 for that sector. For example, if a social event such a protest or riot occurred in a particular sector, which resulted in a recent downward trend in sector score, investment instrument development module 430 may generate an investment instrument 432 including a proposition parameter 434 that the sector score 410 will decrease by a particular amount within an expiration period parameter 434.

Once investment instrument 432 is generated, AEM computing device 102 is configured to transmit a program initiation signal 437 to a program interface (PI) computing device 106 (shown in FIG. 1). PI computing device 106 is configured to maintain a virtual commodity market for the buying and selling of various kinds of investment instruments (e.g., stock options, binary options, futures, etc.) 432 within an option program 433. Program initiation signal 437 includes the generated investment instrument 432 (and any associated parameters 434) as well as instructions for PI computing device 106 to offer investment instrument 432 for sale on a virtual commodity market as part of options program 433. Program initiation signal 437 may further include instructions for PI computing device 106 to transmit activation signals to user computing device(s) 104, causing user computing device(s) 104 to activate and display the investment instruments 432 available for purchase. PI computing device 106 may store or otherwise maintain received investment instruments 432 in options program 433 and/or records thereof.

PI computing device 106 includes a virtual commodity market module 440 configured to implement the virtual commodity market for access by a plurality of user computing device 104 (e.g., buyer and seller user computing devices). Virtual commodity market module 440 may include instructions for display of the virtual commodity market as a website and/or downloadable software application including an interactive user interface (UI) with which users of user computing device 104 may interact with virtual commodity market module 440 (e.g., to buy and sell investment instruments 432).

Virtual commodity market module 440 is configured to offer investment instruments 432 for sale in options programs 433. Virtual commodity market module 440 may index, sort, filter, and/or display available investment instruments 432 according to parameters 434 (e.g., price or value, expiration period, etc.) and/or according to associated sectors. For example, virtual commodity market module 440 may facilitate filtering of available investment instruments 432 according to a city searched or requested by user computing device 104 (e.g., “Boston, MA”).

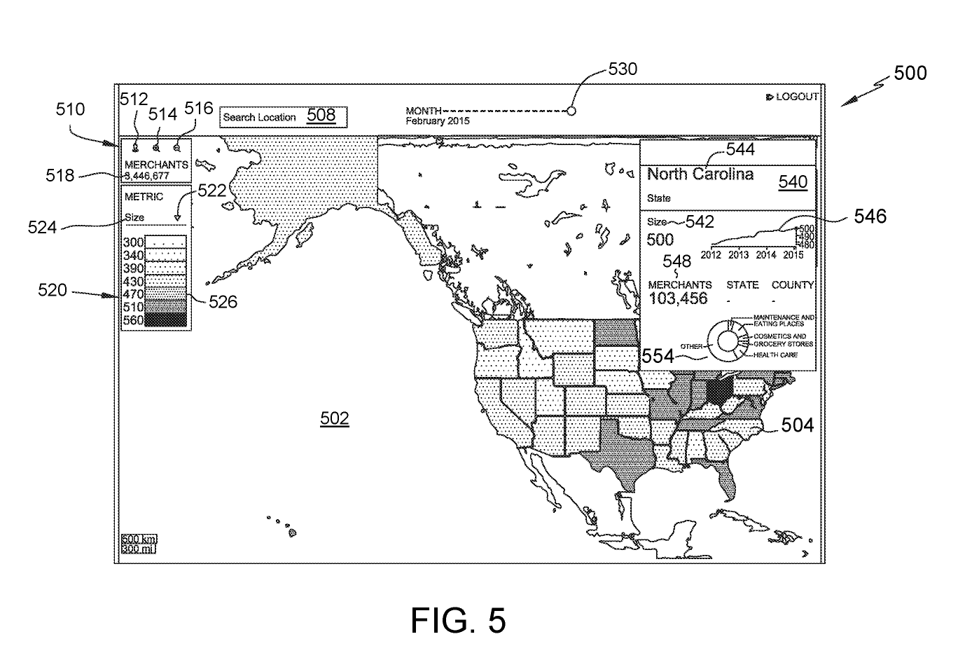

Virtual commodity market module 440 may be further configured to facilitate display of sector score(s) 410 using the UI on user computing device(s) 104. For example, as described herein, virtual commodity market module 440 may facilitate display of sectors on a map (see FIG. 5), with associated sector scores 410 displayed thereon for review by user(s) associated with user computing device(s) 104. Alternatively, virtual commodity market module 440 may provide a link (e.g., a URL) to such a graphical display of sector score(s).

At least one of AEM computing device 102 and PI computing device 106 is configured to receive a purchase signal 441 from user computing device 104. Purchase signal 441 includes an identification of a financial instrument 432 that was purchased as well as a commission identification. The commission identification includes an indication that a commission was generated by the purchase of investment instrument 432 and further includes a commission amount 452. AEM computing device 102 may receive purchase signal 441 and forward purchase signal 441 to PI computing device 106 with instructions to initiate commission division 406. Alternatively, PI computing 106 may receive purchase signal 441 and forward purchase signal 441 to AEM computing device 102 with instructions to initiate commission division 406.

In either embodiment, AEM computing device 102 may store a purchase record 462 of purchase signal 441. Purchase record 462 may include a date of the purchase, which investment instrument(s) 432 were purchased, and associated parameters 424 thereof, such as an expiration date. AEM computing device 102 is configured to monitor purchase records 462 for expiration dates and/or any other parameters 424, such that AEM computing device 102 may transmit a notification signal (not specifically shown) to user computing device 104 upon expiration of purchased investment instrument 432. The notification signal may include an identification of how much the user of user computing device 104 earned or lost, a current value of investment instrument 432, and/or additional, associated information. In addition, PI computing device 106 may receive a conversion signal (not shown) from user computing device 104 including an indication that the user of user computing device 104 wishes to convert (e.g., sell, “cash-out”, convert, trade, etc.) a purchased investment instrument 432. AEM computing device 102 may retrieve purchase record 462 to retrieve parameters 424 of the purchased investment instrument 432 in order to determine a current value of the investment instrument 432. AEM computing device 102 may then transmit the notification signal to user computing device 104.

In the illustrated embodiment, AEM computing device 102 is configured to transmit an initiation signal 451 to transaction processor 412 (see FIG. 4B) to initiate commission division 406. Initiation signal 451 includes commission amount 452 and instructions on how commission amount 452 should be divided among respective parties, namely, AEM computing device 102, PI computing device 106, and the sector associated with the purchased investment instrument 432. Commission amount 452 may be a predetermined, standard amount set for any purchase (and/or sale or transfer) of a investment instrument 432, e.g., $0.50. Alternatively, commission amount 452 may be proportional to a purchase or transaction amount associated with the purchase of a investment instrument 432, e.g., 0.5% or 1%. Transaction processor 412 is configured to facilitate transmission of funds (represented by a dashed line) in commission amount 452 from a user bank 454. Transaction processor 412 is further configured to facilitate transfer of shares of those funds (represented by dashed lines) according to the division instructions to a PI bank 456 associated with PI computing device 106, a sector bank 458 associated with the sector, and an AEM bank 460 associated with AEM computing device 102. It should be understood that “bank” may refer to any financial institution and/or account therewith. It should also be understood that although banks 454, 456, 458, and 460 are illustrated as separate banks, any of banks 454, 456, 458, and 460 may be the same institution as one or more others of banks 454, 456, 458, and 460.

FIG. 5 is an example screenshot 500 of a user interface displayed on a user computing device (e.g., client system 104, shown in FIG. 1). The example screenshots include data generated by analytics evaluation and management (AEM) computing device 102 (also shown in FIG. 1) and/or merchant analytics computing device 408 (shown in FIG. 4) such as merchant analytics or sector score 410, as described herein. AEM computing device 102 and/or program interface (PI) computing device 106 communicates the merchant analytics to user computing device 104 for display.

More specifically, FIG. 5 depicts a U.S.-level screenshot 500 showing a “zoomed out” view 502 of the United States of America. In view 502, the sectors are defined and displayed at a state-wide level. It should be understood that although not shown, other views are available, including county- or city-level views. The screenshot 500 also includes several tools that enable a user to navigate the user interface and to examine defined sectors and sector score(s) 410 associated therewith. For example, the screenshot 500 depicts a location search bar 508, which enables the user to search for a geographic region of interest. The screenshot 500 also includes a view navigation module 510. The view navigation module 510 includes a “view type” selectable icon 512, which enables the user to toggle between a “street map” view (as shown in view 502) and a “satellite” view (not shown). The view navigation module 510 also includes “zoom out” 514 and “zoom in” 516 selectable icons. The view navigation module 510 further includes a merchant number indicator 518, which indicates the number of merchants encompassed by the current view (3,446,677 in view 502).

The screenshot 500 further includes a metric information module 520. The metric information module 520 allows the user to select between available merchant analytics metrics (e.g., Composite, Growth, Stability, Size, Traffic, and Ticket Size scores) using a drop-down menu 522. In the example embodiment, the metric information module 520 further includes a score scale 526, which provides an explanation to the user of the color-coding of the sectors. The sectors displayed in view 502 are shown “painted” with colors and/or shades corresponding to the score scale 526, which visually indicates the relative score (for the selected metric 524) for each sector. When a user chooses a different metric using drop-down menu 522, the user interface will “re-paint” (i.e., re-color or re-shade) the displayed sectors (and, in some cases, the score scale 526) to reflect a range of numerical scores according to the selected metric 524. In the example embodiment, a darker color indicates a higher score. In view 502, the selected metric 524 is “Size.” Accordingly, sector scores provided on the user interface are size scores for selected sectors. The screenshot 500 also depicts a time-selection slider 530, which enables a user to “scroll through time” to view sector scores for desired time periods.

The screenshot 500 also depicts a “smart chart” 540, which provides the user with a score 542 for a selected sector 504, as well as additional information. In view 502, North Carolina is the selected sector 504, as indicated by the sector indicator 544 of the smart chart 540. The smart chart 540 includes, in view 502, a size score 542 for North Carolina (a score of 500 in view 502). As view 502 depicts sectors at a state level, the size score 542 for North Carolina is relative to all other states. The smart chart 540 also includes a trend graph 546, which is a visual representation of the size score trends for the selected sector 504 (North Carolina) over time. The smart chart 540 also includes its own merchant number indicator 548, which indicates the number of merchants included in the selected sector 504 (North Carolina). The smart chart 540 also includes an industry chart 554 (a pie chart in the illustrated embodiment), which indicates the percentage of merchant locations in the selected sector 504 associated with various industries.

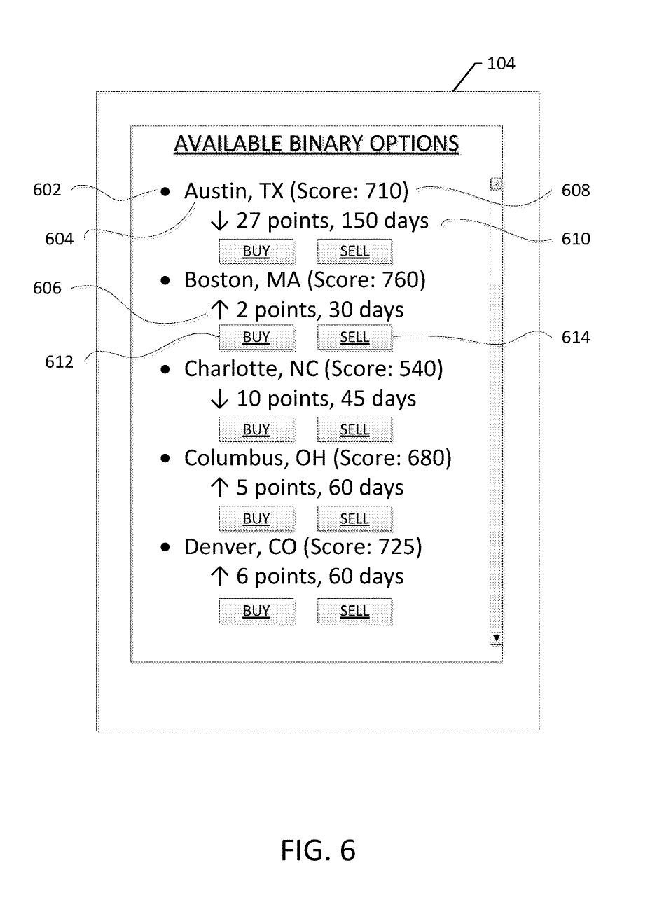

FIG. 6 illustrates a user computing device 104 (as shown in FIG. 1) depicting a first screenshot 600 of investment instruments 602 offered for sale on a commodity market (e.g., by program interface (PI) computing device 106, shown in FIG. 1). Investment instruments 602 may be similar to investment instruments 432 (shown in FIG. 4). In the illustrated embodiment, investment instruments 602 are binary options. Each binary option 602 is associated with a respective sector 604, which are cities in the illustrated embodiment. Each binary option 602 includes a proposition parameter 606 associated with a sector score 608 for the respective sector 604. Each sector score 608 may be a current or most recently reported or generated score for the respective sector 604. As described herein, sector score 604 may include a growth score, size score, traffic score, ticket size score, stability score, or composite score. Each binary option 602 further includes an expiration period parameter 610.

A user (not shown) of user computing device 104 is presented with a buy control 612 and a sell control 614 for each binary option 602. The user may select buy control 612 to purchase the corresponding binary option 602, indicating that they believe the corresponding proposition parameter 606 will be fulfilled within the corresponding expiration period parameter 610. The user may select the sell control 614 to sell to the corresponding binary option 602, indicating that they believe the corresponding proposition parameter 606 will not be fulfilled within the corresponding expiration period parameter 610. Selecting either the buy or sell controls 612, 614 represents a purchase of the corresponding binary option 602 at a price corresponding to the current odds of either outcome occurring. For example, if the proposition parameter 606 is likely to be fulfilled and/or about 75% of users have chosen to “buy” a binary option 602, a “buy” purchase may cost $7.50, and a “sell” purchase may cost $2.50. The user's earnings (or losses) correspond to the actual outcome at the end of expiration period 610. Continuing with the same example, if a user chose to “buy” the binary option 602, and the proposition parameter 606 was fulfilled, that user would earn $2.50 (minus any fees or charges, such as the commission generated for each purchase). If a user chose to “sell” the binary option 602, and the proposition parameter 606 was fulfilled, that user would lose earn nothing. However, if a user chose to “sell” the binary option 602, and the proposition parameter 606 was not fulfilled, that use would earn $7.50 (minus any fees or charges, such as the commission generated for each purchase). It should be understood that the total amount available for each binary option 602 may be other than $10.00 and/or that earnings may not always be equal to the difference in odds.

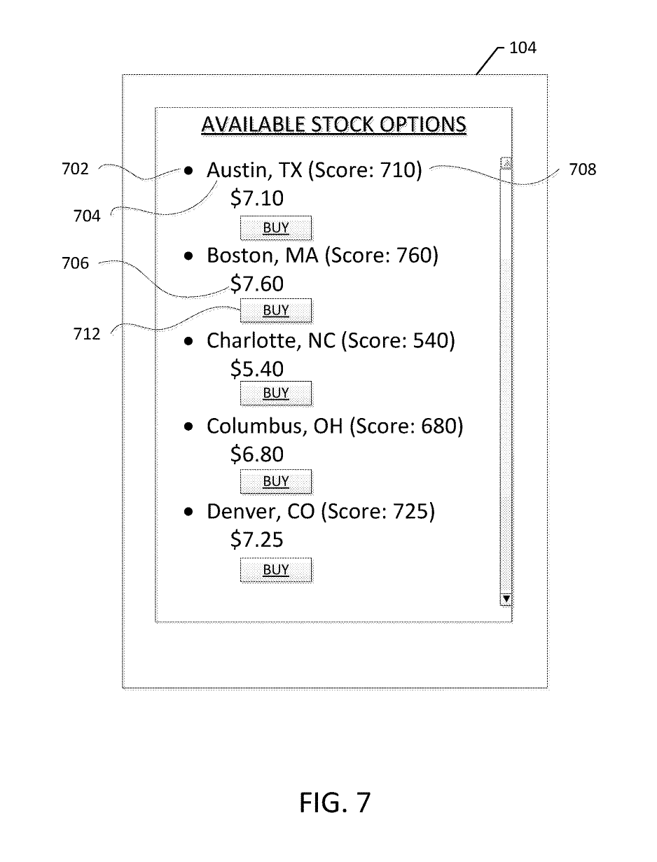

FIG. 7 illustrates a user computing device 104 (as shown in FIG. 1) depicting a second screenshot 700 of investment instruments 702 offered for sale on a commodity market (e.g., by program interface (PI) computing device 106, shown in FIG. 1). Investment instruments 702 may be similar to investment instruments 432 (shown in FIG. 4). In the illustrated embodiment, investment instruments 702 are stock options. Each stock option 702 is associated with a respective sector 704, which are cities in the illustrated embodiment. Each stock option 702 includes a value parameter 706 associated with a sector score 708 for the respective sector 704. Each sector score 708 may be a current or most recently reported or generated score for the respective sector 704. As described herein, sector score 704 may include a growth score, size score, traffic score, ticket size score, stability score, or composite score.

Although value parameters 706 are shown to be 1% of the corresponding sector scores 708, it should be understood that value parameters 706 may be otherwise correlated to sector scores 708. For example, in alternative embodiments, value parameters 706 may be equal to sector score 708, 50% of sector scores 708, 10% of sector scores 708, and/or any other correlation thereto. A user (not shown) of user computing device 104 is presented with a buy control 712 for each stock option 702. The user may select buy control 712 to purchase the corresponding stock option 702, for a price indicated by value parameter 706 (and any fees or charges, such as a commission amount).

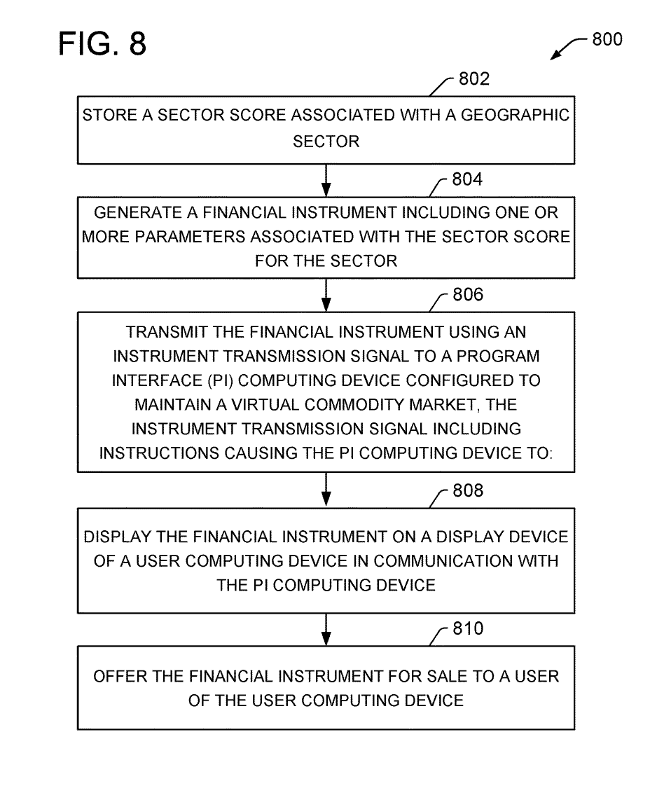

FIG. 8 is a simplified diagram of an example method 800 for creating and managing an options program that is associated with payment transactions initiated within a geographic sector using sector analytics system 100 (shown in FIG. 1). One or more steps of method 800 may be implemented using analytics evaluation and management (AEM) computing device 102 and/or program interface (PI) computing device 106 (both shown in FIG. 1).

Method 800 includes storing 802 a sector score (e.g., sector score 410, shown in FIG. 4) associated with a geographic sector. As described herein, the sector store ranks one or more financial characteristics of a plurality of merchants located in the sector in comparison to other sectors. Method 800 also includes generating 804 a financial instrument (e.g., one or more of financial instrument 432, shown in FIG. 4, financial instrument 602, shown in FIG. 6, and/or financial instrument 702, shown in FIG. 7) including one or more parameters (e.g., parameters 434, shown in FIG. 4, parameters 606 and/or 610, shown in FIG. 6, and/or parameters 706, shown in FIG. 7) associated with the sector score for the sector.

Method 800 further includes transmitting 806 the financial instrument using an instrument transmission signal (e.g., program initiation signal 437, shown in FIG. 4) to PI computing device 106 configured to maintain a virtual commodity market. The instrument transmission signal includes instructions for the receiving computing device (i.e., PI computing device 106) to implement further steps. More specifically, the instrument transmission signal includes instructions causing PI computing device 104 to display 808 the financial instrument on a display device of a user computing device (e.g., user computing device 104, shown in FIG. 1) in communication with PI computing device 104. The instrument transmission signal also includes instructions causing PI computing device 104 to offer 810 the financial instrument for sale to a user of the user computing device.

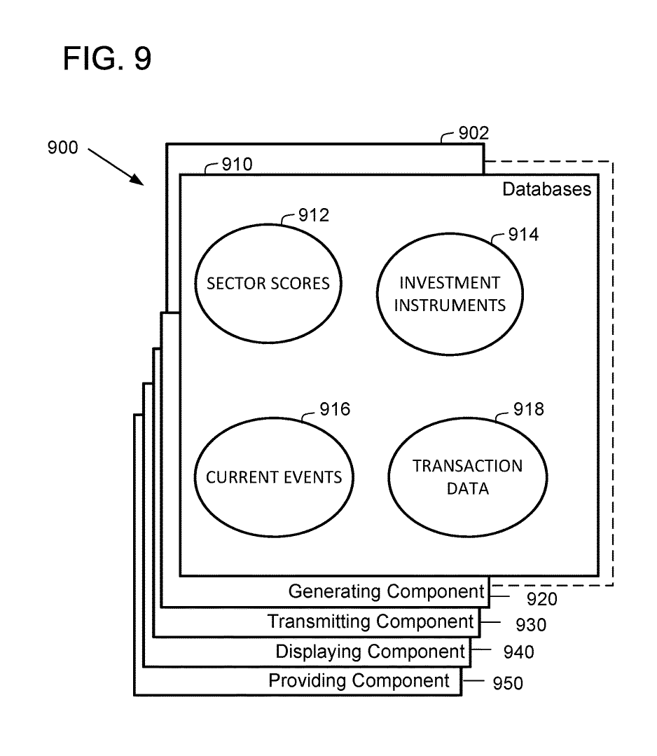

FIG. 9 is a diagram 900 of components of one or more example computing devices 902 that may be used in sector analytics system 100 (shown in FIG. 1). Computing device 902 may include, for example, analytics evaluation and management (AEM) computing device 104 and/or program interface (PI) computing device 106 (both shown in FIG. 1). A database 910 may store information such as, for example, sector scores 912, investment instruments 914, current events 916, and transaction data 918. As described herein, sector stores 912 rank one or more financial characteristics of a plurality of merchants located in a sector in comparison to other sectors. Database 910 is coupled to several separate components within computing device 902, which perform specific tasks.

In particular, computing device 902 includes a generating component 920 configured to generate an investment instrument (e.g., investment instrument 914) including one or more parameters associated with sector score 912 for the sector. Computing device 902 also includes a transmitting component 930 configured to transmit a program initiation signal. In one embodiment, transmitting component 930 transmits the program initiation signal to PI computing device 106. The program initiation signal includes instructions causing a displaying component 940 to display investment instrument 912 on a display device of a user computing device (e.g., user computing device 104, shown in FIG. 1). The instructions also causing a providing component 950 to provide a user of the user computing device an option to purchase investment instrument 912.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A sector analytics system comprising:
an analytics evaluation and management (AEM) computing device including a processor in communication with a memory, said processor programmed to:
store a sector score associated with a geographic sector, the sector store ranking one or more financial characteristics of a plurality of merchants located in the sector in comparison to other sectors;
generate an investment instrument including one or more parameters associated with the sector score for the sector; and
transmit a program initiation signal to a program interface (PI) computing device configured to maintain a virtual commodity market, the program initiation signal including instructions causing the PI computing device to:
display the investment instrument on a display device of a user computing device in communication with the program interface computing device; and
provide a user of the user computing device an option to purchase the investment instrument.

2. The sector analytics system of claim 1, wherein said processor is further programmed to:
receive a purchase signal from the PI computing device indicating a purchase of the investment instrument by the user, the purchase signal including an amount of a commission generated during the purchase;
divide funds in the amount of the commission into a plurality of shares for provision to the PI computing device, the sector, and the sector analytics system; and
provide the plurality of shares to respective ones of the PI computing device, the sector, and the sector analytics system.

3. The sector analytics system of claim 2, further comprising a transaction processor configured to process financial transactions, wherein said processor is further programmed to transmit a commission division signal to said transaction processor, the commission division signal including instructions causing said transaction processor to provide the plurality of shares to financial accounts associated with the respective ones of the PI computing device, the sector, and the sector analytics system.

4. The sector analytics system of claim 3, wherein said processor is further programmed to:
receive transaction data from said transaction processor, the transaction data associated with financial transactions initiated at the plurality of merchants located in the sector; and
generate the sector score using the received transaction data.

5. The sector analytics system of claim 3, wherein said processor is further programmed to receive the sector score from said transaction processor.

6. The sector analytics system of claim 1, wherein the investment instrument comprises a binary option and the one or more parameters includes a proposition associated with a future sector score for the sector.

7. The sector analytics system of claim 1, wherein the investment instrument comprises a stock option associated with the sector and the one or more parameters includes a price of the stock option, wherein the price is correlated with the sector score.

8. The sector analytics system of claim 9, wherein the price of the stock option is equal to the sector score.

9. The sector analytics system of claim 1, wherein the investment instrument includes an expiration interval, and wherein said processor is further programmed to:
receive a purchase signal from the PI computing device indicating a purchase of the investment instrument by the user;
retrieve the one or more parameters of the investment instrument;
calculate an expiration date of the investment instrument based on the expiration interval;
on the expiration date, generate an updated sector score for the sector;
compare the updated sector score to the retrieved one or more parameters;
calculate an amount of money earned or lost by the user; and
transmit a signal to the user computing device indicating the amount of money earned or lost by the user.

10. The sector analytics system of claim 1, wherein said processor is further programmed to:
receive a purchase signal from the PI computing device indicating a purchase of the investment instrument by the user;
subsequently receive a conversion signal from the PI computing device indicating a conversion of the investment instrument by the user;
retrieve the one or more parameters of the investment instrument;
generate an updated sector score for the sector corresponding to a conversion date of the received conversion signal;
compare the updated sector score to the retrieved one or more parameters;
calculate an amount of money earned or lost by the user; and
transmit a signal to the user computing device indicating the amount of money earned or lost by the user.

11. A computer-implemented method for creating and managing an options program associated with payment transactions initiated in a geographic sector, said method implemented using an analytics evaluation and management (AEM) computing device comprising at least one processor in communication with a memory, said method comprising:
storing a sector score associated with the geographic sector, the sector store ranking one or more financial characteristics of a plurality of merchants located in the sector in comparison to other sectors;
generating an investment instrument including one or more parameters associated with the sector score for the sector; and
transmitting a program initiation signal to a program interface (PI) computing device configured to maintain a virtual commodity market, the program initiation signal including instructions causing the PI computing device to:
display the investment instrument on a display device of a user computing device in communication with the program interface computing device; and
provide a user of the user computing device an option to purchase the investment instrument.

12. The computer-implemented method of claim 11 further comprising:
receiving a purchase signal from the PI computing device indicating a purchase of the investment instrument by the user, the purchase signal including an amount of a commission generated during the purchase;
dividing funds in the amount of the commission into a plurality of shares for provision to the PI computing device, the sector, and the AEM computing device; and
providing the plurality of shares to respective ones of the PI computing device, the sector, and the AEM computing device.

13. The computer-implemented method of claim 12 further comprising transmitting a commission divisional signal to a transaction processor configured to process financial transactions, wherein the commission division signal includes instructions causing the transaction processor to provide the plurality of shares to financial accounts associated with the respective ones of the PI computing device, the sector, and the AEM computing device.

14. The computer-implemented method of claim 13 further comprising:
receiving transaction data from the transaction processor, the transaction data associated with financial transactions initiated at the plurality of merchants located in the sector; and
generating the sector score using the received transaction data.

15. The computer-implemented method of claim 11, wherein generating an investment instrument including one or more parameters comprises generating a binary option including a proposition parameter associated with a future sector score for the sector.

16. The computer-implemented method of claim 11, wherein generating an investment instrument including one or more parameters comprises a stock option associated with the sector including a price of the stock option, wherein the price is correlated with the sector score.

17. The computer-implemented method of claim 11, wherein the investment instrument includes an expiration interval, said method further comprising:
receiving a purchase signal from the PI computing device indicating a purchase of the investment instrument by the user;
retrieving the one or more parameters of the investment instrument;
calculating an expiration date of the investment instrument based on the expiration interval;
on the expiration date, generating an updated sector score for the sector;
comparing the updated sector score to the retrieved one or more parameters;
calculating an amount of money earned or lost by the user; and
transmitting a signal to the user computing device indicating the amount of money earned or lost by the user.

18. The computer-implemented method of claim 11 further comprising:
receiving a purchase signal from the PI computing device indicating a purchase of the investment instrument by the user;
subsequently receiving a conversion signal from the PI computing device indicating a conversion of the investment instrument by the user;
retrieving the one or more parameters of the investment instrument;
generating an updated sector score for the sector corresponding to a conversion date of the received conversion signal;
comparing the updated sector score to the retrieved one or more parameters;
calculating an amount of money earned or lost by the user; and
transmitting a signal to the user computing device indicating the amount of money earned or lost by the user.

19. A non-transitory computer-readable storage medium having computer-executable instructions embodied thereon, wherein when executed by an analytics evaluation and management (AEM) computing device including at least one processor in communication with a memory, the computer-executable instructions cause the at least one processor to:
store a sector score associated with a geographic sector, the sector store ranking one or more financial characteristics of a plurality of merchants located in the sector in comparison to other sectors;
generate an investment instrument including one or more parameters associated with the sector score for the sector; and
transmit a program initiation signal to a program interface (PI) computing device configured to maintain a virtual commodity market, the program initiation signal including instructions causing the PI computing device to:
display the investment instrument on a display device of a user computing device in communication with the program interface computing device; and
provide a user of the user computing device an option to purchase the investment instrument.

20. The computer-readable storage medium of claim 19, wherein the computer-executable instructions further cause the at least one processor to:
receive a purchase signal from the PI computing device indicating a purchase of the investment instrument by the user, the purchase signal including an amount of a commission generated during the purchase;
divide funds in the amount of the commission into a plurality of shares for provision to the PI computing device, the sector, and the sector analytics system; and
provide the plurality of shares to respective ones of the PI computing device, the sector, and the sector analytics system.

21. The computer-readable storage medium of claim 20, wherein the computer-executable instructions further cause the at least one processor to transmit a commission division signal to a transaction processor configured to process financial transactions, the commission division signal including instructions causing said transaction processor to provide the plurality of shares to financial accounts associated with the respective ones of the PI computing device, the sector, and the sector analytics system.

22. The computer-readable storage medium of claim 21, wherein the computer-executable instructions further cause the at least one processor to:
receive transaction data from said transaction processor, the transaction data associated with financial transactions initiated at the plurality of merchants located in the sector; and
generate the sector score using the received transaction data.

23. The computer-readable storage medium of claim 19, wherein the investment instrument comprises a binary option and the one or more parameters includes a proposition associated with a future sector score for the sector.

24. The computer-readable storage medium of claim 19, wherein the investment instrument comprises a stock option associated with the sector and the one or more parameters includes a price of the stock option, wherein the price is correlated with the sector score.

25. The computer-readable storage medium of claim 19, wherein the investment instrument includes an expiration interval, and wherein the computer-executable instructions further cause the at least one processor to:
receive a purchase signal from the PI computing device indicating a purchase of the investment instrument by the user;
retrieve the one or more parameters of the investment instrument;
calculate an expiration date of the investment instrument based on the expiration interval;
on the expiration date, generate an updated sector score for the sector;
compare the updated sector score to the retrieved one or more parameters;
calculate an amount of money earned or lost by the user; and
transmit a signal to the user computing device indicating the amount of money earned or lost by the user.

26. The computer-readable storage medium of claim 19, wherein the computer-executable instructions further cause the at least one processor to:
receive a purchase signal from the PI computing device indicating a purchase of the investment instrument by the user;
subsequently receive a conversion signal from the PI computing device indicating a conversion of the investment instrument by the user;
retrieve the one or more parameters of the investment instrument;
generate an updated sector score for the sector corresponding to a conversion date of the received conversion signal;
compare the updated sector score to the retrieved one or more parameters;
calculate an amount of money earned or lost by the user; and
transmit a signal to the user computing device indicating the amount of money earned or lost by the user.
